(19) United States
(12) Patent Application Publication
(10) Pub. No.: US 2024/0195561 A1
(43) Pub. Date: Jun. 13, 2024

(54) METHODS AND APPARATUSES FOR A SENSING-BASED TRANSMISSION

(71) Applicant: LENOVO (BEIJING) LIMITED, Beijing (CN)

(72) Inventors: Xiaodong Yu, Beijing (CN); Zhennian Sun, Beijing (CN); Haipeng Lei, Beijing (CN); Xin Guo, Beijing (CN)

(21) Appl. No.: 18/553,104

(22) PCT Filed: Mar. 29, 2021
(86) PCT No.: PCT/CN2021/083527

§ 371 Date: Sep. 28, 2023

(51) Int. Cl. H04L 5/00; H04W 72/1263; H04W 72/40; H04W 92/18

(52) U.S. Cl. CPC H04L 5/0048; H04W 72/1263; H04W 72/40; H04W 92/18

(57) ABSTRACT

Embodiments of the present disclosure relate to methods and apparatuses for a sensing-based transmission in a sidelink wireless communication system in 3GPP (3rd Generation Partnership Project) 5G networks. According to an embodiment of the present disclosure, a method which may be performed by user equipment (UE) includes: receiving configuration information including a slot total number of a set of candidate resources in a resource pool; and receiving configuration information including another slot total number of another set of candidate resources in the resource pool.

### TECHNICAL FIELD

Embodiments of the present application are related to wireless communication technology, and more particularly, related to methods and apparatuses for a sensing-based transmission in a sidelink wireless communication system in 3GPP (3rd Generation Partnership Project) 5G networks.

### BACKGROUND

A sidelink is a long-term evolution (LTE) feature introduced in 3GPP Release 12, and enables a direct communication between proximal UEs, and data does not need to go through a base station (BS) or a core network. A sidelink communication system has been introduced into 3GPP 5G wireless communication technology, in which a direct link between two user equipments (UEs) is called a sidelink.

3GPP 5G networks are expected to increase network throughput, coverage, and robustness and reduce latency and power consumption. With the development of 3GPP 5G networks, various aspects need to be studied and developed to perfect the 5G technology. Currently, details regarding a sensing-based transmission in a sidelink wireless communication system have not been discussed in 3GPP 5G technology yet.

### SUMMARY

Some embodiments of the present application provide a method, which may be performed by a user equipment (UE). The method includes: receiving configuration information including a slot total number of a set of candidate resources in a resource pool; and receiving configuration information including another slot total number of another set of candidate resources in the resource pool.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a transmission UE.

Some embodiments of the present application provide a method which may be performed by a BS. The method includes: transmitting configuration information including a slot total number of a set of candidate resources in a resource pool; and transmitting configuration information including another slot total number of another set of candidate resources in the resource pool.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a reception BS.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1 illustrates an exemplary sidelink wireless communication system in accordance with some embodiments of the present application;

FIG. 2 illustrates an exemplary partial sensing scheme in a sidelink system according to some embodiments of the present application;

FIG. 3 illustrates a flow chart of a method for receiving configuration information including a slot total number of a set of candidate resources according to some embodiments of the present application;

FIG. 4 illustrates a flow chart of a method for transmitting configuration information including a slot total number of a set of candidate resources according to some embodiments of the present application;

FIG. 5 illustrates a further exemplary partial sensing scheme according to some embodiments of the present application; and

FIG. 6 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, B5G, 6G, and so on. It is contemplated that along with developments of network architectures and new service scenarios, all embodiments in the present application are also applicable to similar technical problems; and moreover, the terminologies recited in the present application may change, which should not affect the principle of the present application.

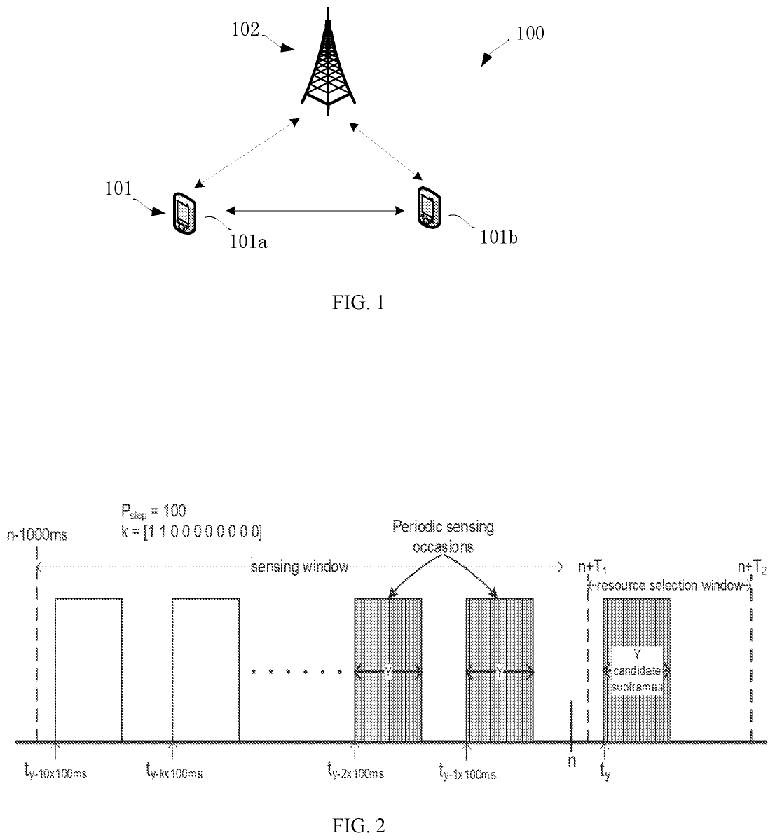

FIG. 1 illustrates an exemplary sidelink wireless communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

In some embodiments of the present application, a UE is a pedestrian UE (P-UE or PUE) or a cyclist UE. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via LTE or NR Uu interface.

In some embodiments of the present application, each of UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in UE(s) 101 may be varied and not limited.

In a sidelink communication system, a transmission UE may also be named as a transmitting UE, a Tx UE, a sidelink Tx UE, a sidelink transmission UE, or the like. A reception UE may also be named as a receiving UE, a Rx UE, a sidelink Rx UE, a sidelink reception UE, or the like.

According to some embodiments of FIG. 1, UE 101a functions as a Tx UE, and UE 101b functions as a Rx UE. UE 101a may exchange sidelink messages with UE 101b through a sidelink, for example, PC5 interface as defined in 3GPP TS 23.303. UE 101a may transmit information or data to other UE(s) within the sidelink communication system, through sidelink unicast, sidelink groupcast, or sidelink broadcast. For instance, UE 101a transmits data to UE 101b in a sidelink unicast session. UE 101a may transmit data to UE 101b and other UEs in a groupcast group (not shown in FIG. 1) by a sidelink groupcast transmission session. Also, UE 101a may transmit data to UE 101b and other UEs (not shown in FIG. 1) by a sidelink broadcast transmission session.

Alternatively, according to some other embodiments of FIG. 1, UE 101b functions as a Tx UE and transmits sidelink messages, UE 101a functions as a Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

UE(s) 101 may access BS(s) 102 to receive data packets from BS(s) 102 via a downlink channel and/or transmit data packets to BS(s) 102 via an uplink channel. In normal operation, since UE(s) 101 does not know when BS(s) 102 will transmit data packets to it, UE(s) 101 has to be awake all the time to monitor the downlink channel (e.g., a Physical Downlink Control Channel (PDCCH)) to get ready for receiving data packets from BS(s) 102. However, if UE(s) 101 keeps monitoring the downlink channel all the time even when there is no traffic between BS(s) 102 and UE(s) 101, it would result in significant power waste, which is problematic to a power limited UE or a power sensitive UE.

Currently, a long-term evolution vehicle to everything (“LTE-V2X” or “LTE-V”) partial-sensing mechanism allows a pedestrian UE (P-UE) to monitor a subset of subframes, rather than an entire sensing window as mandated for a full-sensing mechanism, in order to reduce power consumption when communicating to vehicle UE(s) (V-UE(s)). Generally, only one type of periodic traffic (e.g., with 100 ms period) was considered in a LTE partial sensing mechanism, the associated sensing slots may be determined based on Y values (or minimum number of candidate slots Y) and the partial sensing pattern comprising of the interval between the partial sensing slots P_step (Pₛₜₑₚ). Pₛₜₑₚ may also be named as Pᵣₑₛₑᵣᵥₑ or the like. The parameter Pᵣₑₛₑᵣᵥₑ is a periodicity value from the configured set of possible resource reservation periods.

In addition, a LTE-V's partial-sensing mechanism is designed particularly for a periodic traffic, by virtue of a UE assuming that the UE can determine a candidate resource (e.g., in time instance t_{y} in time domain) within a resource selection window based on the periodic reservation by other UEs, wherein a periodic reservation (e.g., K×Pᵣₑₛₑᵣᵥₑ in time domain) may be determined based on a bitmap, e.g., with a length of 10 bits. The parameter t_{y} is included in the set of Y candidate slots. The parameter K is (pre-)configuration of a bitmap in a LTE-V partial-sensing mechanism. This is because a P-UE typically transmits with periodicity of max 1000 ms and latency of 100 ms, and hence, a maximum of 10 sensing slots would be sufficient within a 1000 ms window whilst minimizing power consumption. For a given configuration, Pᵣₑₛₑᵣᵥₑ is a fixed value. Possible periodicity value (Pᵣₑₛₑᵣᵥₑ) may be any one of the following: 0, [1:99], 100, 200, 300, 400, 500, 600, 700, 800, 900, or 1000 ms. In a TDD configuration, Pᵣₑₛₑᵣᵥₑ is treated as a logical value in a resource pool to represent the physical reservation value, and is not larger than 100 ms in physical time domain. A UE monitors any subframe t_{y-K×P}_{ᵣₑₛₑᵣᵥₑ} when the k-th bit of the bitmap is “1”, wherein the bitmap was used to represent different periodic reservation values, to determine t_{y}. A specific example is shown in FIG. 2.

FIG. 2 illustrates an exemplary partial sensing scheme in a sidelink system according to some embodiments of the present application. The embodiments of FIG. 2 assume that a partial sensing scheme in a sidelink system is optimized for a periodic traffic type only.

As shown in FIG. 2, when a resource selection is triggered in time instance “n” in time domain, a resource selection window starts from time instance “n+T1” and ends at time instance “n+T2”, and Y candidate subframes in the resource selection window starts from time instance “t_{y}”. The embodiments of FIG. 2 assume that Pₛₜₑₚ is set to 100 ms and 20 ms or 50 ms reservation periodicities were not taken into consideration. In the embodiments of FIG. 2, a UE performs monitoring of subframes in sensing occasions according to t_{y-K×P}_{ₛₜₑₚ} (or t_{y-K×P}_{ᵣₑₛₑᵣᵥₑ}) for a set of Y candidate subframes determined within the resource selection window. The embodiments of FIG. 2 also assume that and K is set as a bitmap with a length of 10 bits, i.e., [1100000000] as shown in FIG. 2. Period sensing occasions within the sensing window are determined by the Kth bit of a higher layer parameter, e.g., gapCandidateSensing.

As shown in FIG. 2, a sensing window includes multiple periodic sensing occasions from time instance “n−1000 ms” to time instance “n” in time domain. Corresponding to K=[1100000000], the first periodic sensing occasion starts from time instance “t_{y-1×100 ms}”, the second periodic sensing occasion starts from time instance “t_{y-2×100 ms}”, and each of the first and second periodic sensing occasions includes Y subframes.

Embodiments of the present application take the above sidelink partial sensing scheme as a baseline, and provide enhancements for a power constrained UE configured with partial sensing to perform a periodic transmission in NR sidelink Mode 2. In Mode 2, a UE decides sidelink transmission resource(s) in time and frequency domains in a resource pool. For instance, NR sidelink will support multiple types of periodic traffic in one resource pool and multiple types of periodic traffic may have the same ratio or different ratios. Or, multiple types of periodic traffic may have different types of transmissions, e.g., a data traffic transmission, or a sidelink position reference signalling transmission. In this way, if a network only configures one Y value, multiple sensing occasions for multiple types of periodic traffic will have the same sensing window size. It may increase the power consumption of the sensing UE. Thus, some embodiments of the present application provide solutions referring to multiple Y values for multiple types of periodic traffic or for different types of transmissions.

In particular, for example, if there are different periodic traffics having the same payload in one resource pool, there may be 50% transmissions with 20 ms period and may be 50% transmissions with 100 ms period but with different configured K values in the resource pool. For this embodiment, Y value of 20 ms should have a larger size for a lower collision probability. In addition, if a common Y value is used for determining different sensing windows in responding to different period traffic, the power consumption is an issue for a power sensitive UE. A UE may not determine a suitable Y value based on itself, because the UE has no knowledge of transmission traffic ratio of each periodic traffic from others UE(s) in the resource pool. Thus, some embodiments of the present application provide solutions to configure multiple Y values to solve these issues.

Specifically, some embodiments of the present application provide mechanisms to define multiple Y values or minimum Y values in responding to different period of traffic (Pᵣₑₛₑᵣᵥₑ or Pₛₜₑₚ) for one resource pool. Some embodiments of the present application provide mechanisms to define multiple K values in responding to different period of traffic (Pᵣₑₛₑᵣᵥₑ or Pₛₜₑₚ) for one resource pool. Some embodiments of the present application provide mechanisms to define multiple Y values or minimum Y values in responding to different transmission types in each piece of resource pool configuration information for multiple resource pools. Some embodiments of the present application perform a resource selection based on two sets of candidate resources. More details will be illustrated in the following text in combination with the appended drawings.

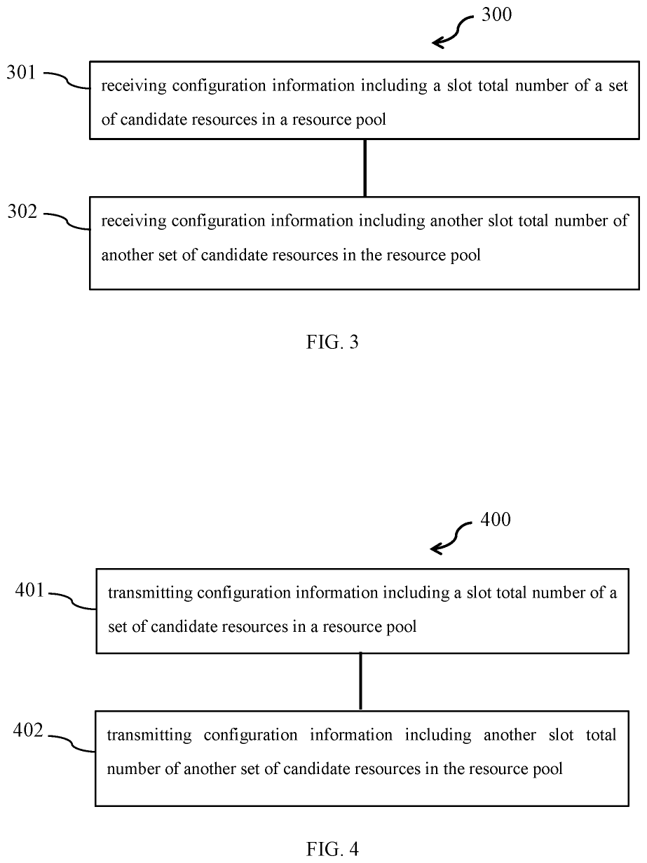

FIG. 3 illustrates a flow chart of a method for receiving configuration information including a slot total number of a set of candidate resources according to some embodiments of the present application. The embodiments of FIG. 3 may be performed by a UE (e.g., UE 101 or UE 102 illustrated and shown in FIG. 1). Although described with respect to a UE, it should be understood that other devices may be configured to perform a method similar to that of FIG. 3.

In the exemplary method 300 as shown in FIG. 3, in operation 301, a UE (e.g., UE 101 illustrated and shown in FIG. 1) receives configuration information including a slot total number (i.e., 1^{st} slot total number, e.g., Y1) of a set of candidate resources (i.e., 1^{st} set of candidate resources) in a resource pool. In operation 302, the UE receives configuration information including another slot total number (i.e., 2^{nd} slot total number, e.g., Y2) of another set of candidate resources (i.e., 2^{nd} set of candidate resources) in the resource pool.

According to some embodiments, if a sidelink data transmission is enabled for the resource pool, the 1^{st} slot total number (e.g., Y1) and/or the 2^{nd} slot total number (e.g., Y2) are associated with the sidelink data transmission. According to some other embodiments, if a sidelink position reference signalling transmission is enabled for the resource pool, the 1^{st} slot total number (e.g., Y1) and/or the 2^{nd} slot total number (e.g., Y2) are associated with the sidelink position reference signalling transmission.

For instance, for multiple resource pools, multiple Y values or minimum Y values are configured respectively corresponding to different transmission types in each piece of resource pool configuration information. When enabling one resource pool for a sidelink data transmission, the configured Y value(s) for a sidelink data transmission is used. When enabling one resource pool for a sidelink position reference signalling transmission, the configured Y value(s) for a sidelink position reference signalling transmission is used.

According to some embodiments, if an aperiodic sidelink data transmission is enabled for the resource pool, the 1^{st} slot total number (e.g., Y1) and/or the 2^{nd} slot total number (e.g., Y2) are associated with the aperiodic sidelink data transmission. For instance, when enabling one resource pool for an aperiodic sidelink data transmission, the configured Y value(s) for an aperiodic sidelink data transmission is used.

According to some other embodiments, if a periodic sidelink data transmission is enabled for the resource pool, the 1^{st} slot total number (e.g., Y1) and/or the 2^{nd} slot total number (e.g., Y2) are associated with the periodic sidelink data transmission. For instance, when enabling one resource pool for a periodic sidelink data transmission, the configured Y value(s) for periodic sidelink data transmission is used. In an embodiment, if the periodic sidelink data transmission is enabled for the resource pool, the 1^{st} slot total number (e.g., Y1) is associated with one traffic period (e.g., 1^{st} traffic period), the 2^{nd} slot total number (e.g., Y2) is associated with another traffic period (e.g., 2^{nd} traffic period), and the 1^{st} traffic period (e.g., Pᵣₑₛₑᵣᵥₑ=100 ms) is different from the 2^{nd} traffic period (e.g., Pᵣₑₛₑᵣᵥₑ=20 ms).

As described above, Pᵣₑₛₑᵣᵥₑ may be any one of: 0, [1:99], 100, 200, 300, 400, 500, 600, 700, 800, 900, or 1000 ms. For example, for one resource pool, multiple Y values or minimum Y values may be configured to correspond to different periods of traffic (Pᵣₑₛₑᵣᵥₑ) as shown in following exemplary table. Although specific values of Pᵣₑₛₑᵣᵥₑ and Y values are configured in the following exemplary table, it is contemplated that other possible value(s) can be (pre-)configured for a resource pool.

| Period of traffic | Y values or minimum Y |
|---|---|
| (Pᵣₑₛₑᵣᵥₑ) | values (i.e., Y candidate slots) |
| 20 ms | 40 |
| 50 ms | 20 |
| 100 ms | 20 |
| 200 ms | 10 |
| 500 ms | 5 |

According to some embodiments, if the periodic sidelink data transmission is enabled for the resource pool, the UE determines the 1^{st} set of candidate resources and/or the 2^{nd} set of candidate resources. In an embodiment, the UE determines the 1^{st} set of candidate resources based on the 1^{st} slot total number (e.g., Y1). A total number of slots in the 1^{st} set of candidate resources may be greater than or equal to the 1^{st} slot total number (e.g., Y1). In a further embodiment, the UE determines the 2^{nd} set of candidate resources based on the 2^{nd} slot total number (e.g., Y2). A total number of slots in the 2^{nd} set of candidate resources may be greater than or equal to the 2^{nd} slot total number (e.g., Y2).

According to some embodiments, if the periodic sidelink data transmission is enabled for the resource pool, the UE may further determine Y value(s) based on a remaining packet delay budget (PDB) or a size of resource selection window. In an embodiment, the UE determines one number by selecting a minimum value within the 1^{st} slot total number and a size of a resource selection window. Alternatively, the UE determines this number by selecting a minimum value within the 1^{st} slot total number and a remaining PDB. That is, for example, the determined Y1 value=minimum {Y1 value configured in operation 301, a remaining PDB or a size of resource selection window}. Then, the UE may determine the 1^{st} set of candidate resources based on the determined number (e.g., the determined Y1 value), and a total number of slots in the 1^{st} set of candidate resources may be greater than or equal to the determined number (e.g., the determined Y1 value).

In a further embodiment, the UE determines another number by selecting a minimum value within the 2^{nd} slot total number and a size of the resource selection window. Alternatively, the UE determines the abovementioned another number by selecting a minimum value within the 1^{st} slot total number and a remaining PDB. That is, for example, the determined Y2 value=minimum {Y2 value configured in operation 301, a remaining PDB or a size of resource selection window}. Then, the UE may determine the 2^{nd} set of candidate resources based on the determined another number (e.g., the determined Y2 value), and a total number of slots in the 2^{nd} set of candidate resources may be greater than or equal to the determined another number (e.g., the determined Y2 value).

According to some embodiments, the UE further receives configuration information including a set of candidate sensing gap values (i.e., 1^{st} set of candidate sensing gap values, e.g., a set of K1 values) corresponding to the 1^{st} slot total number (e.g., Y1). According to some other embodiments, the UE further receives configuration information including another set of candidate sensing gap values (i.e., 2^{nd} set of candidate sensing gap values, e.g., a set of K2 values) corresponding to the 2^{nd} slot total number (e.g., Y2).

According to some embodiments, if a sidelink data transmission is enabled for the resource pool, the 1^{st} set of candidate sensing gap values (e.g., a set of K1 values) and/or the 2^{nd} set of candidate sensing gap values (e.g., a set of K2 values) are associated with the sidelink data transmission. According to some other embodiments, if a sidelink position reference signalling transmission is enabled for the resource pool, the 1^{st} set of candidate sensing gap values (e.g., a set of K1 values) and/or the 2^{nd} set of candidate sensing gap values (e.g., a set of K2 values) are associated with the sidelink position reference signalling transmission.

For instance, for multiple resource pools, multiple K values are configured respectively corresponding to different transmission types in each piece of resource pool configuration information. When enabling one resource pool for a sidelink data transmission, the configured K value(s) for a sidelink data transmission is used. When enabling one resource pool for a sidelink position reference signalling transmission, the configured K value(s) for a sidelink position reference signalling transmission is used.

According to some embodiments, if an aperiodic sidelink data transmission is enabled for the resource pool, the 1^{st} set of candidate sensing gap values (e.g., a set of K1 values) and/or the 2^{nd} set of candidate sensing gap values (e.g., a set of K2 values) are associated with the aperiodic sidelink data transmission. For instance, when enabling one resource pool for an aperiodic sidelink data transmission, the configured K value(s) for an aperiodic sidelink data transmission is used.

According to some other embodiments, if a periodic sidelink data transmission is enabled for the resource pool, the 1^{st} set of candidate sensing gap values (e.g., a set of K1 values) and/or the 2^{nd} set of candidate sensing gap values (e.g., a set of K2 values) are associated with the periodic sidelink data transmission. For instance, when enabling one resource pool for a periodic sidelink data transmission, the configured K value(s) for periodic sidelink data transmission is used.

In an embodiment, if the periodic sidelink data transmission is enabled for the resource pool, the 1^{st} set of candidate sensing gap values (e.g., a set of K1 values) are associated with one traffic period (e.g., 1^{st} traffic period), the 2^{nd} set of candidate sensing gap values (e.g., a set of K2 values) is associated with another traffic period (e.g., 2^{nd} traffic period), and the 1^{st} traffic period (e.g., Pᵣₑₛₑᵣᵥₑ=100 ms) is different from the 2^{nd} traffic period (e.g., Pᵣₑₛₑᵣᵥₑ=20 ms).

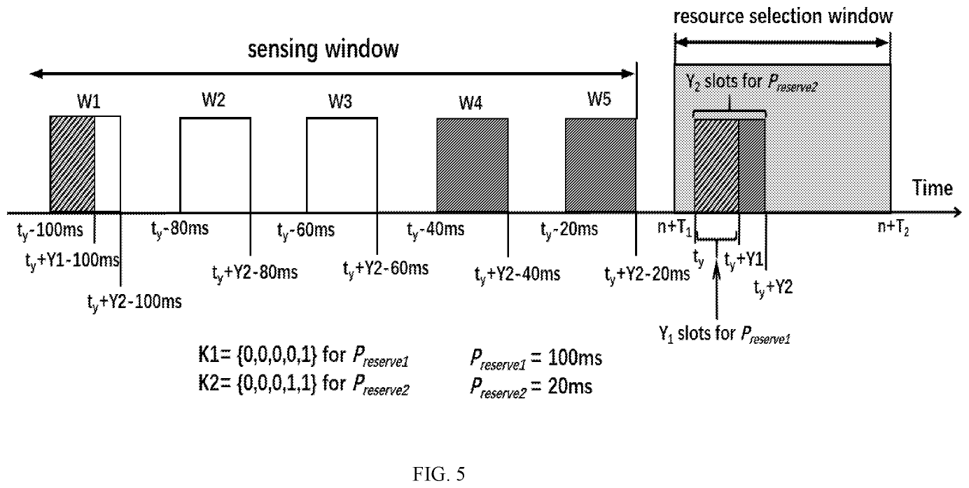

According to some embodiments, if a periodic sidelink data transmission is enabled for the resource pool, the UE determines 1^{st} sensing window occasion(s) associated with the 1^{st} set of candidate resources based on the 1^{st} set of candidate sensing gap values (e.g., a set of K1 values) and/or determines 2^{nd} sensing window occasion(s) associated with the 2^{nd} set of candidate resources based on the 2^{nd} set of candidate sensing gap values (e.g., a set of K2 values). In some embodiments, the UE further performs a resource selection procedure based on the 1^{st} set of candidate resources and/or the 2^{nd} set of candidate resources. In particular, if the 1^{st} set of candidate resources is overlapped with the 2^{nd} set of candidate resources in time domain, the UE may determine an overlapped subset of the 1^{st} set of candidate resources and the 2^{nd} set of candidate resources, and then select candidate resource(s) from the overlapped subset based on the 1^{st} sensing window occasion(s) and the 2nd sensing window occasion(s). In an embodiment, the UE may further determine whether a resource total number of the selected candidate resource(s) is less than a threshold. If the resource total number of the selected candidate resource(s) is less than the threshold, the UE may further determine a non-overlapped subset of the 1st set of candidate resources and the 2^{nd} set of candidate resources, and further select additional candidate resource(s) from the non-overlapped subset based on the 1st sensing window occasion(s) and the 2^{nd} sensing window occasion(s). A specific example is shown in FIG. 5.

According to some embodiments, 1^{st} set of candidate sensing gap values and/or 2^{nd} set of candidate sensing gap values are represented in a bitmap manner. For example, if a periodic sidelink data transmission is enabled for the resource pool, for each period of traffic (Pᵣₑₛₑᵣᵥₑ), a set of K values can be (pre-)configured as a bitmap. Pᵣₑₛₑᵣᵥₑ may be any one of: 0, [1:99], 100, 200, 300, 400, 500, 600, 700, 800, 900, or 1000 ms. For one resource pool, multiple sets of K values may be configured to correspond to different periods of traffic (Pᵣₑₛₑᵣᵥₑ) as shown in following exemplary table. The sizes of these sets of K values are the same, e.g., bitmap a length of 10 bits. Although specific values of Pᵣₑₛₑᵣᵥₑ and K values and a specific length of a set of K values are configured in the following exemplary table, it is contemplated that other possible value(s) and other possible bitmap length(s) of a set of K values can be (pre-)configured for a resource pool.

| Period of traffic (Pᵣₑₛₑᵣᵥₑ) | K values |
|---|---|
| 20 ms | {1, 0, 1, 0, 1, 0, 1, 0, 1, 0} |
| 50 ms | {0, 0, 1, 0, 1, 0, 1, 0, 1, 0} |
| 100 ms | {0, 0, 0, 0, 1, 0, 1, 0, 1, 0} |
| 200 ms | {0, 0, 0, 0, 0, 0, 0, 1, 0, 1} |
| 500 ms | {0, 0, 0, 0, 0, 0, 0, 0, 0, 1} |

According to some embodiments, 1^{st} set of candidate sensing gap values and/or 2^{nd} set of candidate sensing gap values may include: a candidate sensing gap value representing a most recent sensing occasion before a resource selection window in time domain; or a candidate sensing gap value representing two most recent sensing occasions before the resource selection window in time domain. In particular, if a periodic sidelink data transmission is enabled for the resource pool, multiple sets of K values may correspond to different periods of traffic (Pᵣₑₛₑᵣᵥₑ), and sizes of these sets of K values set may be different. As shown in following exemplary table, a set of K values can be configured as 1 or 2. Here, “1” represents a most recent sensing occasion before a resource selection window in time domain, while “2” represents two most recent sensing occasions before the resource selection window in time domain. For instance, “1” represents a bitmap {1}, i.e., only performing sensing for the most recent sensing occasion, and “2” represents a bitmap {1,1}, i.e., only performing sensing for the two most recent sensing occasions. Although specific values of Pᵣₑₛₑᵣᵥₑ and K values are configured in the following exemplary table, it is contemplated that other possible value(s) can be (pre-)configured for a resource pool.

| Period of traffic (Pᵣₑₛₑᵣᵥₑ) | K values |
|---|---|
| 20 ms | 1 or 2 |
| 50 ms | 1 or 2 |
| 100 ms | 1 or 2 |
| 200 ms | 1 or 2 |
| 500 ms | 1 or 2 |

Details described in the embodiments as illustrated and shown in FIGS. 1, 2, and 4-6, especially, contents related to (pre-)configurations of Y values and K values for a sensing-based transmission in a sidelink communication system, are applicable for the embodiments as illustrated and shown in FIG. 3. Moreover, details described in the embodiments of FIG. 3 are applicable for all the embodiments of FIGS. 1, 2, and 4-6.

FIG. 4 illustrates a flow chart of a method for transmitting configuration information including a slot total number of a set of candidate resources according to some embodiments of the present application. The method illustrated in FIG. 4 may be implemented by a network, e.g., a BS (e.g., BS 102 as shown and illustrated in FIG. 1). Although described with respect to a RAN node, e.g., a SN, it should be understood that other devices may be configured to perform a method similar to that of FIG. 4.

In the exemplary method 400 as shown in FIG. 4, in operation 401, a network (e.g., BS 102 as illustrated and shown in FIG. 1) transmits configuration information including a slot total number (i.e., 1^{st} slot total number, e.g., Y1) of a set of candidate resources (i.e., 1^{st} set of candidate resources) in a resource pool. In operation 402, the network transmits configuration information including another slot total number (i.e., 2^{nd} slot total number, e.g., Y2) of another set of candidate resources (i.e., 2^{nd} set of candidate resources) in the resource pool.

According to some embodiments, if a sidelink data transmission is enabled for the resource pool, the 1^{st} slot total number (e.g., Y1) and/or the 2^{nd} slot total number (e.g., Y2) are associated with the sidelink data transmission. According to some other embodiments, if a sidelink position reference signalling transmission is enabled for the resource pool, the 1^{st} slot total number (e.g., Y1) and/or the 2^{nd} slot total number (e.g., Y2) are associated with the sidelink position reference signalling transmission.

According to some embodiments, if an aperiodic sidelink data transmission is enabled for the resource pool, the 1^{st} slot total number (e.g., Y1) and/or the 2^{nd} slot total number (e.g., Y2) are associated with the aperiodic sidelink data transmission. For instance, when enabling one resource pool for an aperiodic sidelink data transmission, the configured Y value(s) for an aperiodic sidelink data transmission is used.

According to some other embodiments, if a periodic sidelink data transmission is enabled for the resource pool, the 1^{st} slot total number (e.g., Y1) and/or the 2^{nd} slot total number (e.g., Y2) are associated with the periodic sidelink data transmission. For instance, when enabling one resource pool for a periodic sidelink data transmission, the configured Y value(s) for periodic sidelink data transmission is used. In an embodiment, if the periodic sidelink data transmission is enabled for the resource pool, the 1^{st} slot total number (e.g., Y1) is associated with one traffic period (e.g., 1^{st} traffic period), the 2^{nd} slot total number (e.g., Y2) is associated with another traffic period (e.g., 2^{nd} traffic period), and the 1^{st} traffic period (e.g., Pᵣₑₛₑᵣᵥₑ=100 ms) is different from the 2^{nd} traffic period (e.g., Pᵣₑₛₑᵣᵥₑ=20 ms).

According to some embodiments, if the periodic sidelink data transmission is enabled for the resource pool, the 1^{st} set of candidate resources is determined based on the 1^{st} slot total number (e.g., Y1), and a total number of slots in the 1^{st} set of candidate resources is greater than or equal to the 1^{st} slot total number (e.g., Y1). According to some other embodiments, the 2^{nd} set of candidate resources is determined based on the 2^{nd} slot total number (e.g., Y2), and a total number of slots in the 2^{nd} set of candidate resources is greater than or equal to the 2^{nd} slot total number (e.g., Y2).

According to some embodiments, if the periodic sidelink data transmission is enabled for the resource pool, Y value(s) can be further determined based on a remaining PDB or a size of resource selection window. In an embodiment, one number is determined as a minimum value within the 1^{st} slot total number and a size of a resource selection window. Alternatively, this number is determined as a minimum value within the 1^{st} slot total number and a remaining PDB. For example, the determined Y1 value=minimum {Y1 value configured in operation 301, a remaining PDB or a size of resource selection window}. Then, the 1^{st} set of candidate resources may be determined based on the determined number (e.g., the determined Y1 value), and a total number of slots in the 1^{st} set of candidate resources is greater than or equal to the determined number (e.g., the determined Y1 value).

In a further embodiment, another number is determined as a minimum value within the 2^{nd} slot total number and a size of the resource selection window. Alternatively, the abovementioned another number is determined as a minimum value within the 1^{st} slot total number and a remaining PDB. For example, the determined Y2 value=minimum {Y2 value configured in operation 301, a remaining PDB or a size of resource selection window}. Then, the 2^{nd} set of candidate resources may be determined based on the determined another number (e.g., the determined Y2 value), and a total number of slots in the 2^{nd} set of candidate resources is greater than or equal to the determined another number (e.g., the determined Y2 value).

According to some embodiments, the network further transmits configuration information including a set of candidate sensing gap values (i.e., 1^{st} set of candidate sensing gap values, e.g., a set of K1 values) corresponding to the 1^{st} slot total number (e.g., Y1). According to some other embodiments, the network further transmits configuration information including another set of candidate sensing gap values (i.e., 2^{nd} set of candidate sensing gap values, e.g., a set of K2 values) corresponding to the 2^{nd} slot total number (e.g., Y2).

According to some embodiments, if a sidelink data transmission is enabled for the resource pool, the 1^{st} set of candidate sensing gap values (e.g., a set of K1 values) and/or the 2^{nd} set of candidate sensing gap values (e.g., a set of K2 values) are associated with the sidelink data transmission. According to some other embodiments, if a sidelink position reference signalling transmission is enabled for the resource pool, the 1^{st} set of candidate sensing gap values (e.g., a set of K1 values) and/or the 2^{nd} set of candidate sensing gap values (e.g., a set of K2 values) are associated with the sidelink position reference signalling transmission.

According to some embodiments, if an aperiodic sidelink data transmission is enabled for the resource pool, the 1^{st} set of candidate sensing gap values (e.g., a set of K1 values) and/or the 2^{nd} set of candidate sensing gap values (e.g., a set of K2 values) are associated with the aperiodic sidelink data transmission. For instance, when enabling one resource pool for an aperiodic sidelink data transmission, the configured K value(s) for an aperiodic sidelink data transmission is used.

According to some other embodiments, if a periodic sidelink data transmission is enabled for the resource pool, the 1^{st} set of candidate sensing gap values (e.g., a set of K1 values) and/or the 2^{nd} set of candidate sensing gap values (e.g., a set of K2 values) are associated with the periodic sidelink data transmission. For instance, when enabling one resource pool for a periodic sidelink data transmission, the configured K value(s) for periodic sidelink data transmission is used.

In an embodiment, if the periodic sidelink data transmission is enabled for the resource pool, the 1^{st} set of candidate sensing gap values (e.g., a set of K1 values) are associated with one traffic period (e.g., 1^{st} traffic period), the 2^{nd} set of candidate sensing gap values (e.g., a set of K2 values) is associated with another traffic period (e.g., 2^{nd} traffic period), and the 1^{st} traffic period (e.g., Pᵣₑₛₑᵣᵥₑ=100 ms) is different from the 2^{nd} traffic period (e.g., Pᵣₑₛₑᵣᵥₑ=20 ms).

According to some embodiments, if a periodic sidelink data transmission is enabled for the resource pool, 1^{st} sensing window occasion(s) associated with the 1st set of candidate resources may be determined based on the 1^{st} set of candidate sensing gap values (e.g., a set of K1 values) and/or 2^{nd} sensing window occasion(s) associated with the 2^{nd} set of candidate resources may be determined based on the 2^{nd} set of candidate sensing gap values (e.g., a set of K2 values). A specific example is shown in FIG. 5.

According to some embodiments, 1^{st} set of candidate sensing gap values and/or 2^{nd} set of candidate sensing gap values are represented in a bitmap manner. For example, if a periodic sidelink data transmission is enabled for the resource pool, for each period of traffic (Pᵣₑₛₑᵣᵥₑ), sets of K values can be (pre-)configured as a bitmap.

According to some embodiments, 1^{st} set of candidate sensing gap values and/or 2^{nd} set of candidate sensing gap values include: a candidate sensing gap value representing a most recent sensing occasion before a resource selection window in time domain; or a candidate sensing gap value representing two most recent sensing occasions before the resource selection window in time domain. In particular, for example, a set of K values can be configured as 1 or 2. For instance, “1” represents a bitmap {1}, i.e., only performing sensing for the most recent sensing occasion, and “2” represents a bitmap {1,1}, i.e., only performing sensing for the two most recent sensing occasions.

Details described in the embodiments as illustrated and shown in FIGS. 1-3, 5, and 6, especially, contents related to (pre-)configurations of Y values and K values for a sensing-based transmission in a sidelink communication system, are applicable for the embodiments as illustrated and shown in FIG. 4. Moreover, details described in the embodiments of FIG. 4 are applicable for all the embodiments of FIGS. 1-3, 5, and 6.

FIG. 5 illustrates a further exemplary partial sensing scheme according to some embodiments of the present application.

In the embodiments of FIG. 5, a periodic sidelink data transmission is enabled for a resource pool. A resource selection window starts from time instance “n+T1” and ends at time instance “n+T2”. The embodiments of FIG. 5 assume that Pᵣₑₛₑᵣᵥₑ₁ is set to 100 ms and Pᵣₑₛₑᵣᵥₑ₂ is set to 20 ms, and assume that a set of candidate resources for Pᵣₑₛₑᵣᵥₑ₁ is overlapped with a set of candidate resources for Pᵣₑₛₑᵣᵥₑ₂ in time domain. A set of Y1 slots for Pᵣₑₛₑᵣᵥₑ₁ in the resource selection window starts from time instance “t_{y}” and ends at time instance “t_{y}+Y1”. A set of Y2 slots for Pᵣₑₛₑᵣᵥₑ₂ in the resource selection window starts from time instance “t_{y}” and ends at time instance “t_{y}+Y2”. The embodiments of FIG. 5 also assume that and K1 and K2 are set as a bitmap with a length of 5 bits, i.e., K1=[00001] for Pᵣₑₛₑᵣᵥₑ₁ and K2=[00011] for Pᵣₑₛₑᵣᵥₑ₂.

As shown in FIG. 5, a sensing window includes multiple sensing window occasions (e.g., periodic partial sensing window occasions W1, W2, W3, W4, and W5) from time instance “t_{y}+Y2−20 ms” in time domain. Corresponding to K1=[00001] for Pᵣₑₛₑᵣᵥₑ₁, a UE determines that 1^{st} sensing window occasion(s) associated with the set of Y1 slots for Pᵣₑₛₑᵣᵥₑ₁ based on K1 values include a sub-partial sensing window within W1, which starts from time instance “t_{y}-1×100 ms” (i.e., t_{y}−100 ms) and ends at time instance “t_{y}+Y1−100 ms”. Corresponding to K2=[00011] for Pᵣₑₛₑᵣᵥₑ₂, the UE determines that 2^{nd} sensing window occasion(s) associated with the set of Y2 slots for Pᵣₑₛₑᵣᵥₑ₂ based on K2 values include W5 and W4. W5 starts from time instance “t_{y}−1×20 ms” (i.e., t_{y}−20 ms) and ends at time instance “t_{y}+Y2−20 ms”, and W4 starts from time instance “t_{y}−2×20 ms” (i.e., t_{y}−40 ms) and ends at time instance “t_{y}+Y2−40 ms”.

In the embodiments of FIG. 5, since two sets of candidate resources for Pᵣₑₛₑᵣᵥₑ₁ and for Pᵣₑₛₑᵣᵥₑ₂ are overlapped in time domain, the UE determines the overlapped subset (i.e., Y1 slots for Pᵣₑₛₑᵣᵥₑ₁) and selects candidate resource(s) from the overlapped subset based on 1^{st} and 2^{nd} sensing window occasions which are determined based on K1 and K2 values. In particular, the UE further determines whether a resource total number of the selected candidate resource(s) in Y1 slots for Pᵣₑₛₑᵣᵥₑ₁ is less than a (pre-defined) threshold. If the resource total number of the selected candidate resource(s) is less than the threshold, the UE further determines a non-overlapped subset of two sets of candidate resources for Pᵣₑₛₑᵣᵥₑ₁ and for Pᵣₑₛₑᵣᵥₑ₂, i.e., a subset within Y2 slots for Pᵣₑₛₑᵣᵥₑ₁ which is non-overlapped with Y1 slots for Pᵣₑₛₑᵣᵥₑ₁. Then, the UE further selects additional candidate resource(s) from the non-overlapped subset based on 1^{st} and 2^{nd} sensing window occasions determined based on K1 and K2 values.

Details described in the embodiments as illustrated and shown in FIGS. 1-4 and 6, especially, contents related to (pre-)configurations of Y values and K values for a sensing-based transmission in a sidelink communication system, are applicable for the embodiments as illustrated and shown in FIG. 5. Moreover, details described in the embodiments of FIG. 5 are applicable for all the embodiments of FIGS. 1-4 and 6.

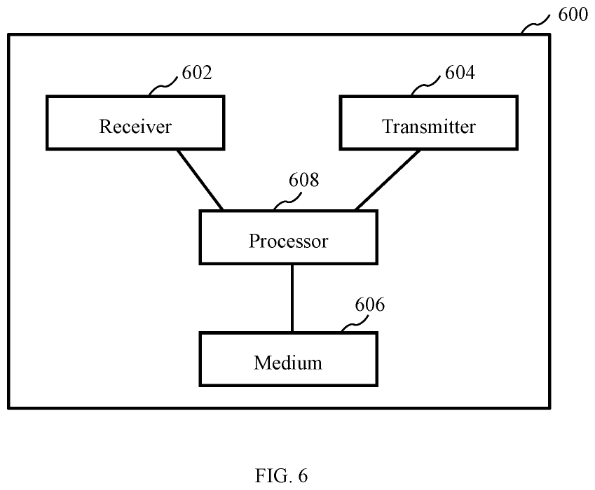

FIG. 6 illustrates an exemplary block diagram of an apparatus according to some embodiments of the present application. In some embodiments of the present application, the apparatus 600 may be a UE, which can at least perform the method illustrated in FIG. 3. In some embodiments of the present application, the apparatus 600 may be a network (e.g., a BS), which can at least perform the method illustrated in FIG. 4.

As shown in FIG. 6, the apparatus 600 may include at least one receiver 602, at least one transmitter 604, at least one non-transitory computer-readable medium 606, and at least one processor 608 coupled to the at least one receiver 602, the at least one transmitter 604, and the at least one non-transitory computer-readable medium 606.

Although in FIG. 6, elements such as the at least one receiver 602, the at least one transmitter 604, the at least one non-transitory computer-readable medium 606, and the at least one processor 608 are described in the singular, the plural is contemplated unless limitation to the singular is explicitly stated. In some embodiments of the present application, the at least one receiver 602 and the at least one transmitter 604 are combined into a single device, such as a transceiver. In certain embodiments of the present application, the apparatus 600 may further include an input device, a memory, and/or other components.

In some embodiments of the present application, the at least one non-transitory computer-readable medium 606 may have stored thereon computer-executable instructions which are programmed to implement the operations of the methods, for example as described in view of any of FIGS. 3-5, with the at least one receiver 602, the at least one transmitter 604, and the at least one processor 608.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

What is claimed is:

1. A method performed by a user equipment (UE), the method comprising:
receiving configuration information including a first slot total number of a first set of candidate resources in a resource pool; and
receiving configuration information including a second slot total number of a second set of candidate resources in the resource pool.

2. The method of claim 1, wherein:
in response to enabling the resource pool for a sidelink data transmission, at least one of the first slot total number and the second slot total number is associated with the sidelink data transmission; and
in response to enabling the resource pool for a sidelink position reference signalling transmission, at least one of the first slot total number and the second slot total number is associated with the sidelink position reference signalling transmission.

3. The method of claim 1, wherein:
in response to enabling the resource pool for a periodic sidelink data transmission, at least one of the first slot total number and the second slot total number is associated with the periodic sidelink data transmission; and
in response to enabling the resource pool for an aperiodic sidelink data transmission, at least one of the first slot total number and the second slot total number is associated with the aperiodic sidelink data transmission.

4. The method of claim 3, wherein in response to enabling the resource pool for the periodic sidelink data transmission:
the first slot total number is associated with a first traffic period, the second slot total number is associated with a second traffic period, and the first traffic period is different from the second traffic period.

5. The method of claim 4, further comprising at least one of:
determining the first set of candidate resources based on the first slot total number, wherein a total number of slots in the first set of candidate resources is greater than or equal to the first slot total number; and
determining the second set of candidate resources based on the second slot total number, wherein a total number of slots in the second set of candidate resources is greater than or equal to the second slot total number.

6. The method of claim 4, further comprising at least one of:
determining a first number by selecting a minimum value within the first slot total number and a size of a resource selection window, and determining the first set of candidate resources based on the determined first number, wherein a total number of slots in the first set of candidate resources is greater than or equal to the determined first number; and
determining a second number by selecting a minimum value within the second slot total number and the size of the resource selection window, and determining the second set of candidate resources based on the determined second number, wherein a total number of slots in the second set of candidate resources is greater than or equal to the determined second number.

7. The method of claim 1, further comprising:
receiving configuration information including a first set of candidate sensing gap values corresponding to the first slot total number; and
receiving configuration information including a second set of candidate sensing gap values corresponding to the second slot total number.

8. The method of claim 7, wherein:
in response to enabling the resource pool for a sidelink data transmission, at least one of the first set of candidate sensing gap values and the second set of candidate sensing gap values is associated with the sidelink data transmission; and
in response to enabling the resource pool for a sidelink position reference signalling transmission, at least one of the first set of candidate sensing gap values and the second set of candidate sensing gap values is associated with the sidelink position reference signalling transmission.

9. The method of claim 7, wherein in response to enabling the resource pool for a periodic sidelink data transmission:
the first set of candidate sensing gap values is associated with a first traffic period, the second set of candidate sensing gap values is associated with a second traffic period, and the first traffic period is different from the second traffic period.

10. The method of claim 9, further comprising at least one of:
determining one or more first sensing window occasions associated with the first set of candidate resources based on the first set of candidate sensing gap values; and
determining one or more second sensing window occasions associated with the second set of candidate resources based on the second set of candidate sensing gap values.

11. The method of claim 10, further comprising:
performing a resource selection procedure based on at least one of the first set of candidate resources and the second set of candidate resources.

12. The method of claim 11, wherein performing the resource selection procedure further comprises:
in response to the first set of candidate resources overlapped with the second set of candidate resources in a time domain, determining an overlapped subset of the first set of candidate resources and the second set of candidate resources; and
selecting one or more first candidate resources from the overlapped subset based on the one or more first sensing window occasions and the one or more second sensing window occasions.

13. The method of claim 12, further comprising:
determining whether a resource total number of the one or more first candidate resources is less than a threshold; and
in response to the resource total number less than the threshold:
determining a non-overlapped subset of the first set of candidate resources and the second set of candidate resources; and
further selecting one or more second candidate resources from the non-overlapped subset based on the one or more first sensing window occasions and the one or more second sensing window occasions.

14. An apparatus for performing a network function, the apparatus comprising:
at least one memory; and
at least one processor coupled with the at least one memory and configured to cause the apparatus to:
transmit configuration information including a first slot total number of a first set of candidate resources in a resource pool; and
transmit configuration information including a second slot total number of a second set of candidate resources in the resource pool.

15. (canceled)

16. A processor for wireless communication, comprising:
at least one controller coupled with at least one memory and configured to cause the processor to:
receive configuration information including a first slot total number of a first set of candidate resources in a resource pool; and
receive configuration information including a second slot total number of a second set of candidate resources in the resource pool.

17. A user equipment (UE), comprising:
at least one memory; and
at least one processor coupled with the at least one memory and configured to cause the UE to:
receive configuration information including a first slot total number of a first set of candidate resources in a resource pool; and
receive configuration information including a second slot total number of a second set of candidate resources in the resource pool.

18. The UE of claim 17, wherein:
in response to enabling the resource pool for a sidelink data transmission, at least one of the first slot total number and the second slot total number is associated with the sidelink data transmission; and
in response to enabling the resource pool for a sidelink position reference signalling transmission, at least one of the first slot total number and the second slot total number is associated with the sidelink position reference signalling transmission.

19. The UE of claim 17, wherein:
in response to enabling the resource pool for a periodic sidelink data transmission, at least one of the first slot total number and the second slot total number is associated with the periodic sidelink data transmission; and
in response to enabling the resource pool for an aperiodic sidelink data transmission, at least one of the first slot total number and the second slot total number is associated with the aperiodic sidelink data transmission.

20. The UE of claim 19, wherein in response to enabling the resource pool for the periodic sidelink data transmission:
the first slot total number is associated with a first traffic period, the second slot total number is associated with a second traffic period, and the first traffic period is different from the second traffic period.

21. The UE of claim 20, wherein the at least one processor is further configured to cause the UE to:
determine the first set of candidate resources based on the first slot total number, wherein a total number of slots in the first set of candidate resources is greater than or equal to the first slot total number; and
determine the second set of candidate resources based on the second slot total number, wherein a total number of slots in the second set of candidate resources is greater than or equal to the second slot total number.
